(19) United States
(12) Patent Application Publication
(10) Pub. No.: US 2009/0141490 A1
(43) Pub. Date: Jun. 4, 2009

(54) Method for diminishing dark gap in arrayed led module, arrayed LED module, and imaging apparatus thereof

(75) Inventor: Shang-An Tsai, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,939

(22) Filed: Dec. 1, 2008

(30) Foreign Application Priority Data
Nov. 30, 2007 (TW) 096145516

(51) Int. Cl. F21V 5/00; F21K 7/00

(52) U.S. Cl. 362/231; 362/241

(57) ABSTRACT

The invention discloses an arrayed light emitting diode (LED) module including multiple LED chips and light-reflecting members. Multiple gaps exist between LED chips adjacent to each other. Each of the light-reflecting members respectively is disposed in one of the gaps. The light-reflecting member reflects the light emitted from the LED chips, to diminish the dark gap shown on the illumination region, further to uniform the brightness distribution of the illumination region.

### BACKGROUND OF THE INVENTION

1. Field of the Invention

The invention relates to an arrayed LED module, and particularly relates to an arrayed LED module capable of diminishing a dark gap imaged from the arrayed LED chips.

2. Description of the Prior Art

A light-emitting diode (LED) is a semiconductor object, and is applied to an instruction lamp and a display panel in the early development stages. In recent years, after the development of the white LED, the LED has also been applied to the illumination. Compared with the traditional illumination light source, the LED has advantages of high efficiency, long life span, and high durability.

Generally, a lens or an optical object with a specific shape is used for gathering the light emitted from the LED. Please refer to FIG. 1A˜1C. FIG. 1A is a schematic diagram illustrating an arrayed LED module 10. FIG. 1B is a schematic diagram illustrating an imaging apparatus 1 including the arrayed LED module 10 shown in FIG. 1A. FIG. 1C is a brightness distribution of the illumination region 30 illuminated by the imaging apparatus 1 shown in FIG. 1B. When the arrayed LED module 10 including multiple LED chips 100 (for example, the LED in Ostar series of OSRAM opto semiconductors co.) emits light, the illumination region 30 usually shows a dark region, also called a dark gap. Generally, a gap 102 with 0.1˜0.15 mm width exists between the LED chips 100 adjacent to each other, and there is no light source in the gap 102. Therefore, after the light emitted from the arrayed LED module 10 passes through the lens 12 and illuminates the illumination region 30 on the screen 14, a dark gap corresponding to the gap 102 is imaged on the illumination region 30, so the brightness distribution of the illumination region 30 is not uniform.

Accordingly, the invention provides an arrayed LED module with a light-reflecting member and an imaging apparatus thereof to solve the aforesaid problem.

### SUMMARY OF THE INVENTION

A scope of the invention is to provide an arrayed LED module including multiple LED chips and light-reflecting members. Multiple gaps exist between the LED chips adjacent to each other. Each of the light-reflecting members is respectively disposed in one of the gaps. Accordingly, the light-reflecting member can reflect the light emitted from the LED chips to diminish the dark gap to uniform the brightness distribution of the illumination region.

Another scope of the invention is to provide an imaging apparatus including an arrayed LED module and a lens. The arrayed LED module includes multiple LED chips and light-reflecting members. Multiple gaps exist between the LED chips adjacent to each other. Each of the light-reflecting members is respectively disposed in one of the gaps. The light emitted from the LED chips and the light reflected from the light-reflecting members pass through the lens to form an image.

Therefore, the arrayed LED module of the invention utilizes the light-reflecting member to reflect the light emitted from the LED chips, to diminish the dark gap to uniform the brightness distribution of the illumination region.

The advantage and spirit of the invention may be understood by the following recitations together with the appended drawings.

### BRIEF DESCRIPTION OF THE APPENDED DRAWINGS

FIG. 1A is a schematic diagram illustrating an arrayed LED module.

FIG. 1B is a schematic diagram illustrating an imaging apparatus including the arrayed LED module shown in FIG. 1A.

FIG. 1C is a brightness distribution of the illumination region illuminated by the imaging apparatus shown in FIG. 1B.

FIG. 2A is a schematic diagram illustrating an arrayed LED module according to a preferred embodiment of the invention.

FIG. 2B is a cross-section view of the arrayed LED module shown in FIG. 2A along Y-Y line.

FIG. 2C is a schematic diagram illustrating an imaging apparatus including the arrayed LED module shown in FIG. 2A.

FIG. 2D is a brightness distribution of the illumination region illuminated by the imaging apparatus shown in FIG. 2C.

FIG. 3 is a flow chart of the method for diminishing the dark gap imaged by the arrayed LED chips according to the invention.

### DETAILED DESCRIPTION OF THE INVENTION

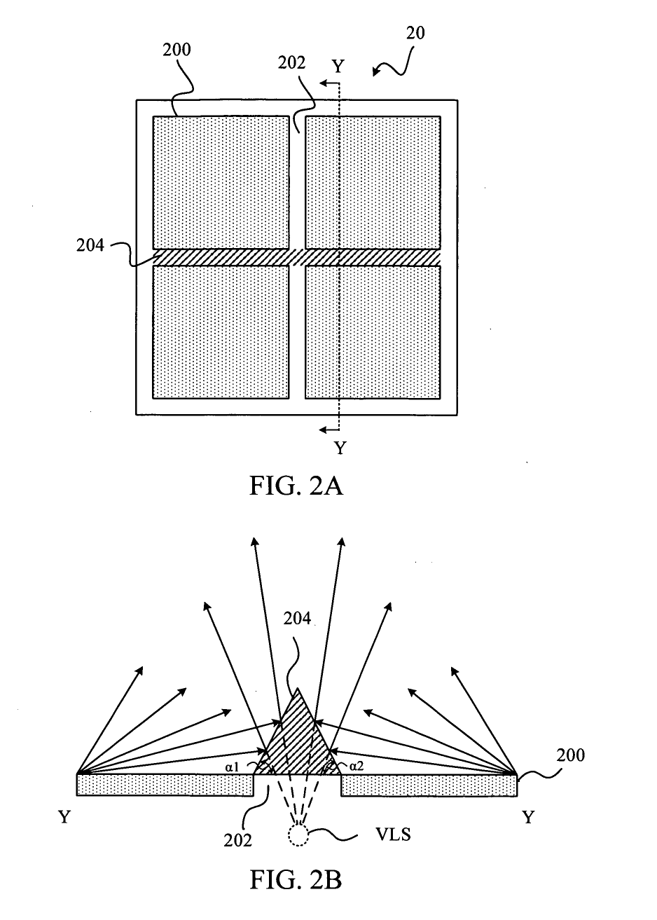

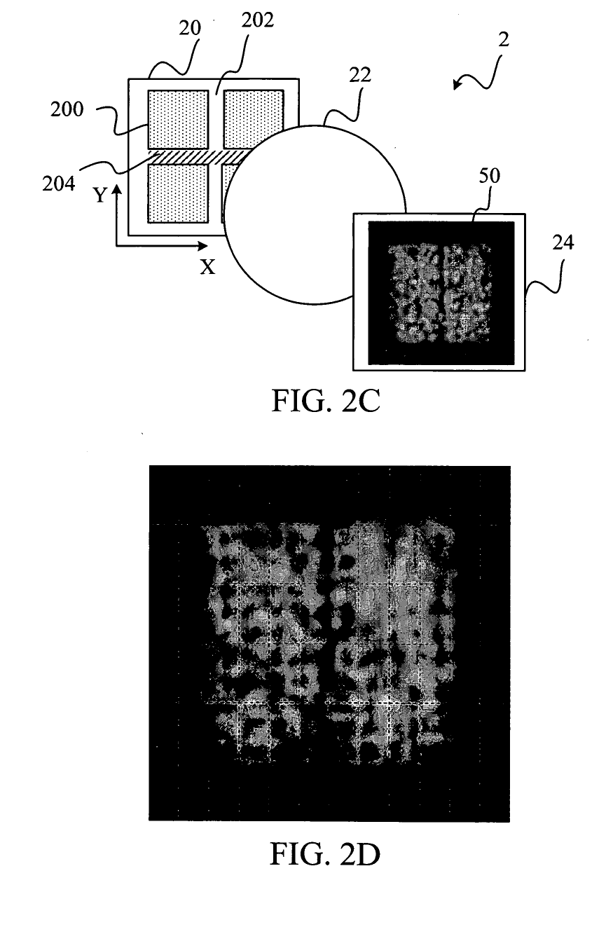

Please refer to FIG. 2A. FIG. 2A is a schematic diagram illustrating an arrayed LED module 20 according to a preferred embodiment of the invention. The arrayed LED module 20 includes multiple LED chips 200 and the light-reflecting member 204. Multiple gaps 202 exist between the LED chips 200 adjacent to each other. Each of the light-reflecting members 204 is respectively disposed in one of the gaps 202. The light-reflecting member 204 can be a triangular prism, a half-column, a half-elliptical column, or other column body, and preferably is the triangular prism. The LED chips 200 can be a blue LED, a red LED, a green LED, or a while LED.

Please refer to FIG. 2B. FIG. 2B is a cross-section view of the arrayed LED module 20 shown in FIG. 2A along the Y-Y line. In this embodiment, the light-reflecting member 204 shown in FIG. 2B is a triangular prism, and two internal angles α1, α2 of the triangular prism can be designed, but not limited to be larger than or equal to 45 degrees, and preferably are 45 degrees. As shown in FIG. 2B, the light-reflecting member 204 can reflect the light emitted from the LED chips 200. The reflected light can be regarded as the light emitted from the virtual light source VLS. Accordingly, the dark gap shown on the illumination region is diminished, so the brightness distribution of the illumination region becomes uniform.

Please refer to FIG. 2C. FIG. 2C is a schematic diagram illustrating an imaging apparatus 2 including the arrayed LED module 20 shown in FIG. 2A. The imaging apparatus 2 includes the arrayed LED module 20, the lens 22, and the screen 24. As shown in FIG. 2C, the light emitted from the LED chips 200 and the light reflected from the light-reflecting members 204 pass through the lens 22 to illuminate the illumination region 50 on the screen 24.

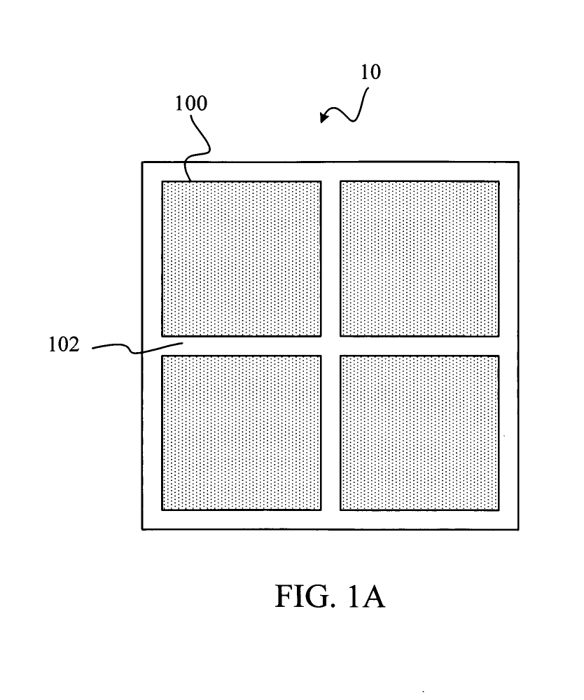

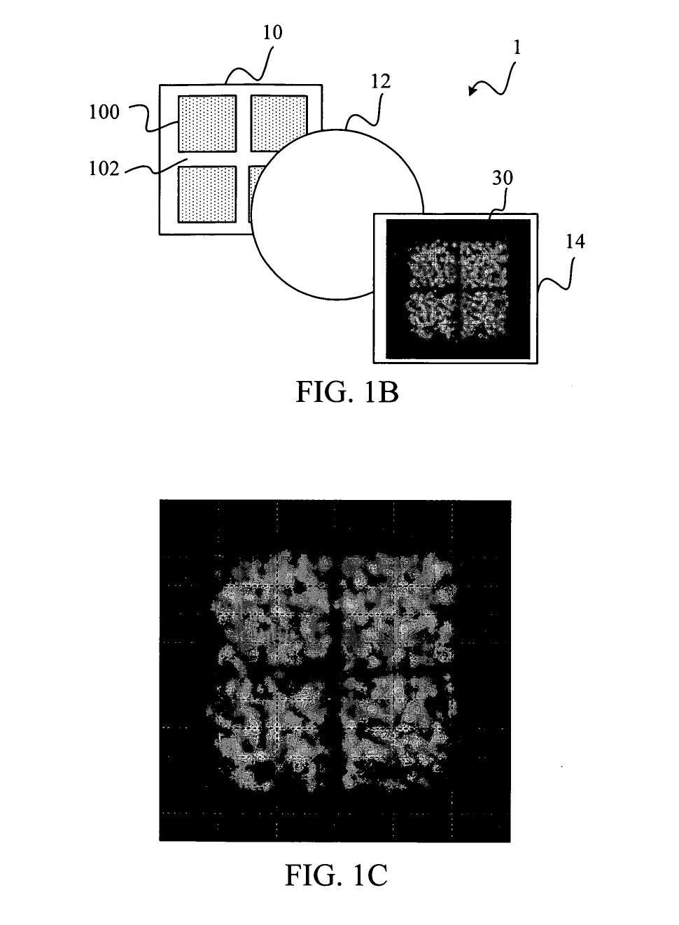

Please refer to FIG. 2C and FIG. 2D. FIG. 2D is a brightness distribution of the illumination region 50 illuminated by the imaging apparatus 2 shown in FIG. 2C. Compared with the brightness distribution (shown in FIG. 1C) of the illumination region 30 illuminated by the traditional imaging apparatus 1 (shown in FIG. 1B), the light reflected from the gap 202 accommodating the light-reflecting member 204 illuminates the screen 24, and does not form an dark gap on the illumination region 50. Apparently, the brightness distribution of the illumination region 50 illuminated by the imaging apparatus 2 of the invention is more uniform than the imaging apparatus 1 in the prior art.

It should be noticed that the light-reflecting member 204 shown in FIG. 2C is only disposed in the gap 202 along X-direction. Therefore, an apparent dark gap of the illumination region 50 is imaged by the gap 202 without the light-reflecting member 204 along Y-direction.

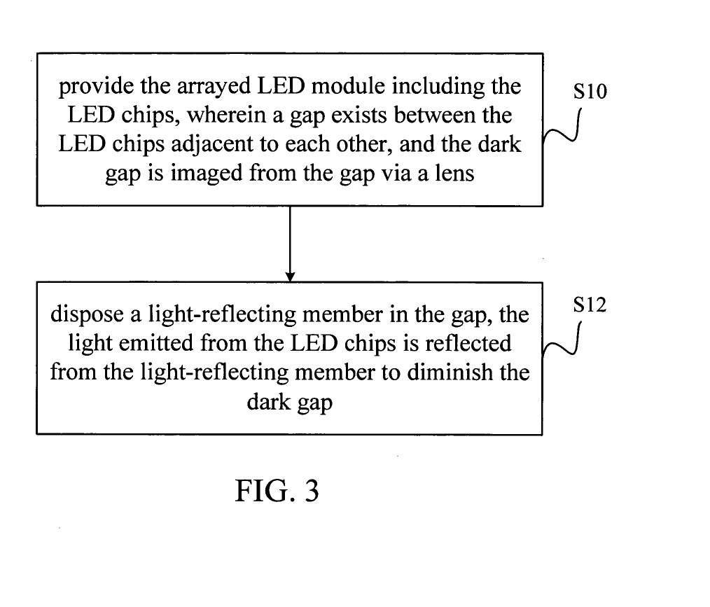

Please refer to FIG. 3. FIG. 3 is a flow chart of the method for diminishing the dark gap imaged by the arrayed LED chips according to the invention. The method includes the following steps.

At first, the step S10 is performed to provide the arrayed LED module 20 including multiple LED chips 200. Multiple gaps 202 exist between the LED chips 200 adjacent to each other, and the dark gap is imaged from the gap 202 via the lens.

Afterward, the step S12 is performed to dispose the light-reflecting members 204 in the gaps 202. The light emitted from the LED chips 200 can be reflected by the light-reflecting members 204, so the light-reflecting members 204 can be regarded as virtual light sources to diminish the dark gap. In detail, the dark gap shown on the screen 24 is imaged from the gap 202 via the lens 22, and the dark gap causes the non-uniform brightness distribution of the illumination region 50. If the light-reflecting members 204 are disposed in the gaps 202, the light-reflecting members can be regarded as virtual light sources in the gaps 202. Alternatively, it seems that there are light sources disposed in the gaps, so the apparent dark gap will not be formed on the screen 24.

Compared with prior art, the imaging apparatus 2 of the invention utilizes the light-reflecting members 204 disposed in the gaps 202 to reflect the light emitted from the LED chips 200. Therefore, the dark gap shown on the illumination region 50 can be diminished, and furthermore the brightness distribution of the illumination region 50 becomes uniform.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An arrayed LED module, comprising:
a plurality of LED chips, a plurality of gaps existing between the LED chips adjacent to each other; and
a plurality of light-reflecting members, each of the light-reflecting members being respectively disposed in one of the gaps.

2. The arrayed LED module of claim 1, wherein each of the light-reflecting members is selected from one of the group consisting of a triangular prism, a half-column, and a half-elliptical column.

3. The arrayed LED module of claim 2, wherein two internal angles of the triangular prism are larger than or equal to 45 degrees.

4. The arrayed LED module of claim 1, wherein each of the LED chips is selected from one of the group consisting of a blue LED chip, a red LED chip, a green LED chip, and a white LED chip.

5. An imaging apparatus, comprising:
an arrayed LED module, comprising:
a plurality of LED chips, a plurality of gaps existing between the LED chips adjacent to each other; and
a plurality of light-reflecting members, each of the light-reflecting members being respectively disposed in one of the gaps; and
a lens, a light emitted from the LED chips and a light reflected from the light-reflecting members passing through the lens to form an image.

6. The imaging apparatus of claim 5, wherein each of the light-reflecting members is selected from one of the group consisting of a triangular prism, a half-column, and a half-elliptical column.

7. The imaging apparatus of claim 6, wherein two internal angles of the triangular prism are larger than or equal to 45 degrees.

8. The imaging apparatus of claim 5, wherein each of the LED chips is selected from one of the group consisting of a blue LED chip, a red LED chip, a green LED chip, and a white LED chip.

9. The imaging apparatus of claim 5, wherein the lens is selected from one of the group consisting of a spherical lens, an aspherical lens, and a cylindrical lens.

10. A method for diminishing a dark gap in an arrayed LED module, the method comprising the following steps of:
(a) providing the arrayed LED module comprising a plurality of LED chips, wherein a gap exists between the LED chips adjacent to each other, the dark gap is imaged from the gap via a lens; and
(b) disposing a light-reflecting member in the gap, a light emitted from the LED chips being reflected from the light-reflecting member to diminish the dark gap.

11. The method of claim 10, wherein each of the light-reflecting members is selected from one of the group consisting of a triangular prism, a half-column, and a half-elliptical column.

12. The method of claim 11, wherein two internal angles of the triangular prism are larger than or equal to 45 degrees.

13. The method of claim 10, wherein each of the LED chips is selected from one of the group consisting of a blue LED chip, a red LED chip, a green LED chip, and a white LED chip.

14. The method of claim 10, wherein the lens is selected from one of the group consisting of a spherical lens, an aspherical lens, and a cylindrical lens.
